(19) United States
(12) Patent Application Publication
(10) Pub. No.: US 2012/0250923 A1
(43) Pub. Date: Oct. 4, 2012

(54) AUDITORY CANAL INSERT WITH A FILTER ELEMENT AND METHOD OF MANUFACTURING THE AUDITORY CANAL INSERT

(75) Inventors: DANIELA BECK, ERLANGEN (DE); BJÖRN FREELS, NURNBERG (DE); ULI GOMMEL, SINGAPORE (SG); SONGHUA YI, ERLANGEN (DE)

(73) Assignee: SIEMENS MEDICAL INSTRUMENTS PTE. LTD., SINGAPORE (SG)

(21) Appl. No.: 13/439,396

(22) Filed: Apr. 4, 2012

(30) Foreign Application Priority Data
Apr. 4, 2011 (DE) 10 2011 006 720.5

(51) Int. Cl. H04R 25/00; B23P 17/04; G10K 11/00

(52) U.S. Cl. 381/328; 181/135; 29/896.21

(57) ABSTRACT

An auditory canal insert is to be produced which can be manufactured simply and cost-effectively and which is less susceptible to dirt, especially cerumen. To this end an auditory canal insert is proposed which has an at least essentially tubular inner section, an outer section lying at least in some area against a user's auditory canal wall when the device is being worn and a filter element, especially a cerumen-protection and/or attenuation element, in which the filter element is initially manufactured as a separate component and subsequently connected by an insert molding process in one piece with the inner section. For the filter element this thus enables a broad spectrum to be covered in respect of its acoustic and mechanical filter characteristics.

### CROSS-REFERENCE TO RELATED APPLICATION

This application claims the priority, under 35 U.S.C. §119, of German application DE 10 2011 006 720.5, filed Apr. 4, 2011; the prior application is here-with incorporated by reference in its entirety.

### BACKGROUND OF THE INVENTION

### Field of the Invention

The invention relates to an auditory canal insert for a hearing aid, wherein the auditory canal insert contains a filter element. Furthermore the invention relates to a hearing aid with such an auditory canal insert as well as to a method for manufacturing an auditory canal insert of this type.

What are referred to as Receiver-In-the-Canal (RIC) hearing aids have become very popular in recent years, they generally contain a device unit able to be worn behind the ear, in which primarily the amplifier, the battery, one or more microphones and other electronic components are arranged in a housing, and an auditory canal insert in the form of an external receiver unit (ERU), which sits in the auditory canal of the user when the device is being worn. The two units are connected to each other via a cable. The receiver unit generally has a shield or mushroom head or dome-shaped section which is generally connected to the rest of the receiver unit detachably, e.g. via a snap-on or latch-on connection. So that the dome makes a good fit in the auditory canal and no pressure points arise, it is usually made of a flexible silicon material at least in the area of its outer circumference. The dome effects an acoustic sealing of the auditory canal in order to prevent feedback, in addition it ensures the mechanical hold and the fixing of the receiver in the auditory canal and protects the receiver against contamination, e.g. from earwax. The protection against contamination is primarily achieved by a grating in the sound outlet opening of the dome. The grating can however become covered by dirt and cerumen (earwax), which means that a smaller acoustically-active surface is produced which causes an unwanted attenuation effect.

As well as auditory canal inserts with a receiver for hearing aids auditory canal inserts for hearing aids able to be worn behind the ear (BTE) are known, which do not have a receiver but in which a sound tube coming from a hearing aid able to be worn behind the ear opens out into the canal. These also frequently have a shield or mushroom head or dome-shaped section. Here too a grating can be provided to protect the sound outlet opening against contamination.

Domes are known which are composed of two components, an outer section and an inner section. The outer section is a flexible outer area of the dome, generally made of the silicon material, which can adapt its shape to the shape of the auditory canal. The inner section is a core of solid plastic or plastic material which for example makes a good snap-on connection to the sound outlet of the receiver possible. A sound channel runs through the inner section which begins at the sound outlet opening of the receiver and opens out into the sound outlet opening of the dome or forms the latter. In the area of the sound outlet opening of the dome the inner section has a grating to protect against contamination of the sound canal or of the receiver, especially by cerumen. The inner section with the grating is manufactured in one operating step by an injection-molding method.

Dirt and cerumen collect on the grating. If the contamination has reached a certain level and the grating is partly covered, the acoustic properties of the dome concerned deteriorate. With further contamination the dome must be replaced.

A hearing aid with an auditory canal insert, a housing part able to be worn behind the ear and a receiver tube connecting the auditory canal insert to the housing part is known from publication European patent application EP 1750480 A1, corresponding to U.S. Pat. No. 7,783,068. In this case the transmission of mechanical vibrations between the auditory canal insert and the housing part via the receiver tube is to be prevented. For this purpose damping elements which damp out mechanical vibrations in the transition area are provided in the area of the connection points between the auditory canal insert and the receiver tube or between the receiver tube and the housing part.

The disadvantage of known hearing aids is that the dome of the auditory canal insert can relatively easily become so badly contaminated that it has to be replaced.

U.S. Pat. No. 6,129,174 describes an auditory canal insert having an acoustic coupler which contains a dome-shaped part and a ring embodied in one piece with the dome-shaped part, by which the receiver unit can be connected to the acoustic coupler via a snap-on, twist-off connection. Furthermore a filter element is embodied in one piece with the coupler.

### SUMMARY OF THE INVENTION

The object of the present invention is thus to specify a dome for an auditory canal insert which can be manufactured easily and at low cost and which is less susceptible to dirt, especially cerumen, than previous auditory canal inserts.

The basic idea of the invention consists of the filter element initially being manufactured as a separate component and subsequently being connected by an insert-molding method in one piece with the rest of the auditory canal insert. The auditory canal insert is thus embodied in one piece with the filter element.

The auditory canal insert in accordance with the invention has the advantage that the initially separately manufactured filter element gives significantly more scope during the manufacturing of the filter element, whereby its acoustic and its dirt-resisting properties can be much better adapted to wishes and requirements. For example the filter element can have a very fine grating structure so that contamination cannot penetrate into the grating. For the acoustic properties especially a desired high acoustic transparency can be achieved.

Furthermore the initially separately manufactured filter element, compared to the previously used grades, exhibits a greatly increased (by around 40%) acoustically-effective surface. A lower attenuation is obtained by this which increases the acoustic performance of a hearing aid provided with the inventive auditory canal insert.

The inventive auditory canal insert can—apart from the filter element—be produced in its entirety from a soft, flexible material, especially a silicon material which when worn makes for a snug fit in the auditory canal.

In a preferred embodiment of the invention the auditory canal insert however contains an essentially tubular comparatively hard inner part as well as a comparatively soft outer part lying at least in some areas against an auditory canal wall of the user when the device is worn, wherein the filter element is initially manufactured as a separate component and subsequently is connected by an insert molding method in one piece to the inner part.

As with the previously used gratings, with the new auditory canal inserts too, the filter element is embodied in one piece with the inner part. It can thus, when the hearing aid is being worn or is being removed from the auditory canal, not inadvertently become detached from the inner part, which increases the safety of the arrangement. The initially separately manufactured filter element however makes possible significantly greater freedom in the determination of the acoustic and mechanical filter properties of the filter element. In particular a significantly smaller grating structure can be achieved by the element so that dirt or cerumen cannot penetrate so easily into the grating structure as is the case with the comparatively large openings compared this element in a conventional filter. The inventive auditory canal insert can thus be worn for significantly longer compared to a conventional auditory canal insert before it is necessary to replace it.

The difficulty in manufacturing an inventive auditory canal insert lies in the fact that the flexible outer part which mostly consists of a silicon material or material containing silicon must be molded on to the comparatively rigid or unyielding inner part. In this case the inner part is subjected to temperatures of more than 120°. In accordance with the invention the filter element is therefore made from a temperature-resistant plastic material. Temperature-resistant within the meaning of the invention means that the plastic material used can be subjected to temperatures which occur with a standard multi-component injection molding method, especially when injection molding a silicon material. Preferably the filter element is made of PEEK, PEK, LCP, PPS, PES or PSU, with the composition of the material used being selected so that this resists temperatures of at least up to 120°. This skillful selection of the materials used thus allows the inner part, the outer part and the filter element to be connected to each other or embodied in one piece.

In one embodiment of the invention the filter element is embodied as a woven material or it contains a woven material.

In another embodiment of the invention the filter element is embodied as a grating or contains a grating. Preferably the grating in this case is made of a metal, a metal alloy or a ceramic, which gives resistance to high temperatures.

The different embodiments allow a great variation of the acoustic or mechanical filter properties.

Preferred embodiments of the invention make provision for the filter element to resist temperatures of up to at least 150° or even a temperature of up to at least 180°. This allows greater freedom in the selection of the silicon material for the outer part or in the choice of the manufacturing process used for the auditory canal insert.

In an especially preferred embodiment of the invention the filter element is embodied as what is referred to as an HF4 filter.

The inventive auditory canal insert is not just intended, but is preferably intended for use with an RIC hearing aid. In this case the auditory canal insert also contains a receiver for converting an electrical signal into an acoustic output signal. Preferably in such cases the receiver and the inner part and thus the receiver and the entire dome are able to be connected detachably to one another, especially by a snap-on connection. The dome can thus be easily replaced if need be.

Other features which are considered as characteristic for the invention are set forth in the appended claims.

Although the invention is illustrated and described herein as embodied in an auditory canal insert with a filter element and a method of manufacturing the auditory canal insert, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a hearing aid with an auditory canal insert according to the prior art;

FIG. 2 is a diagrammatic, sectional view of a dome of the auditory canal insert according to the prior art;

FIG. 3 is a diagrammatic, sectional view of the dome according to the invention; and

FIG. 4 is a flow diagram for manufacturing the dome according to the invention.

### DETAILED DESCRIPTION OF THE INVENTION

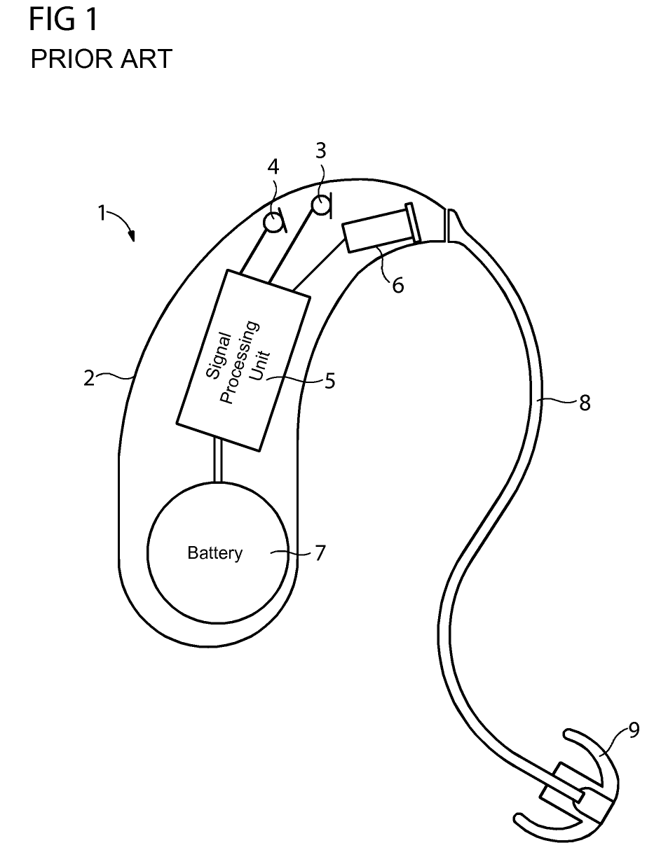

Referring now to the figures of the drawing in detail and first, particularly, to FIG. 1 thereof, there is shown a greatly simplified block diagram of the structure of a hearing aid in accordance with the prior art. Hearing aids basically consist of one or more input converters, an amplifier and an output converter as their essential components. The input converter is as a rule a sound receiver, e.g. a microphone or an electromagnetic receiver e.g. an induction coil. The output converter is mostly realized as an electro-acoustic converter, e.g. miniature loudspeaker or receiver, or as an electromechanical converter, e.g. bone-conduction receiver. The amplifier is usually integrated into a signal processing unit. This basic layout is shown in FIG. 1 using a behind-the-ear hearing aid 1 as an example. Two microphones picking up the sound from the environment are built into a hearing aid housing 2 for wearing behind the ear. A signal processing unit 5 which is likewise integrated into the hearing aid housing processes the microphone signals and amplifies them. The output signal of the signal processing unit 5 is transferred to a loudspeaker or receiver 6, which outputs an acoustic signal. The sound is transmitted to the eardrum of the hearing aid wearer via a sound tube 8 which is fixed with an auditory canal insert 9 in the auditory canal. Energy is supplied to the hearing aid and especially to the signal processing unit by a battery 7, likewise integrated into the hearing aid housing.

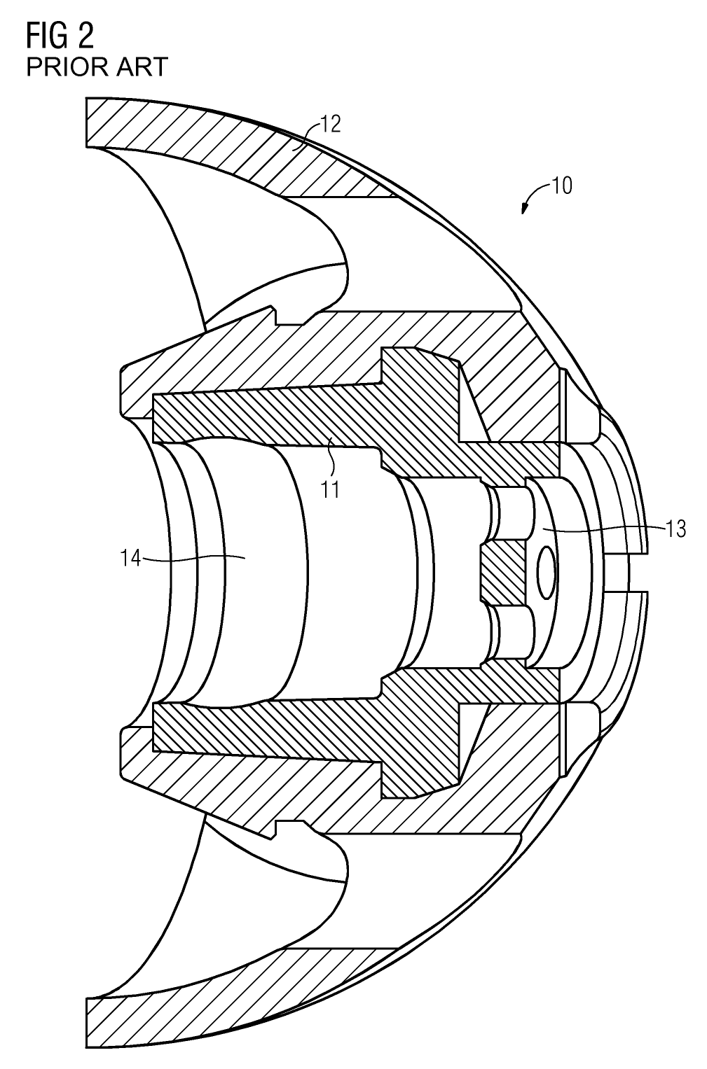

FIG. 2 shows a cross-sectional diagram of an auditory canal insert, especially a dome 10, in accordance with the prior art. The dome 10 generally consists of two parts, a tubular inner section 11 made from a rigid, unyielding plastic material and an outer section 12 connected thereto in one piece made from a soft, flexible plastic material, especially silicon. The rigid inner section 11 in accordance with the exemplary embodiment has a differing diameter along its course and is able to be connected detachably to a non-illustrated receiver by a snap-on connection. For this the inner section 11 of the auditory canal insert 10 especially has a widening out of its internal diameter running in the form of a ring around a specific area 14.

To improve the acoustic characteristics of the auditory canal insert 10 and to protect the receiver against contamination, the dome 10 has a filter element integrated into the inner section 11, especially a cerumen protection and damping element 13. The filter element 13 is formed that the dome 10 in accordance with the prior art by the tubular inner section 11 on its end pointing towards the eardrum when the device is being worn changing from an individual tube with a comparatively large cross-section into a plurality of tubes with smaller cross-section.

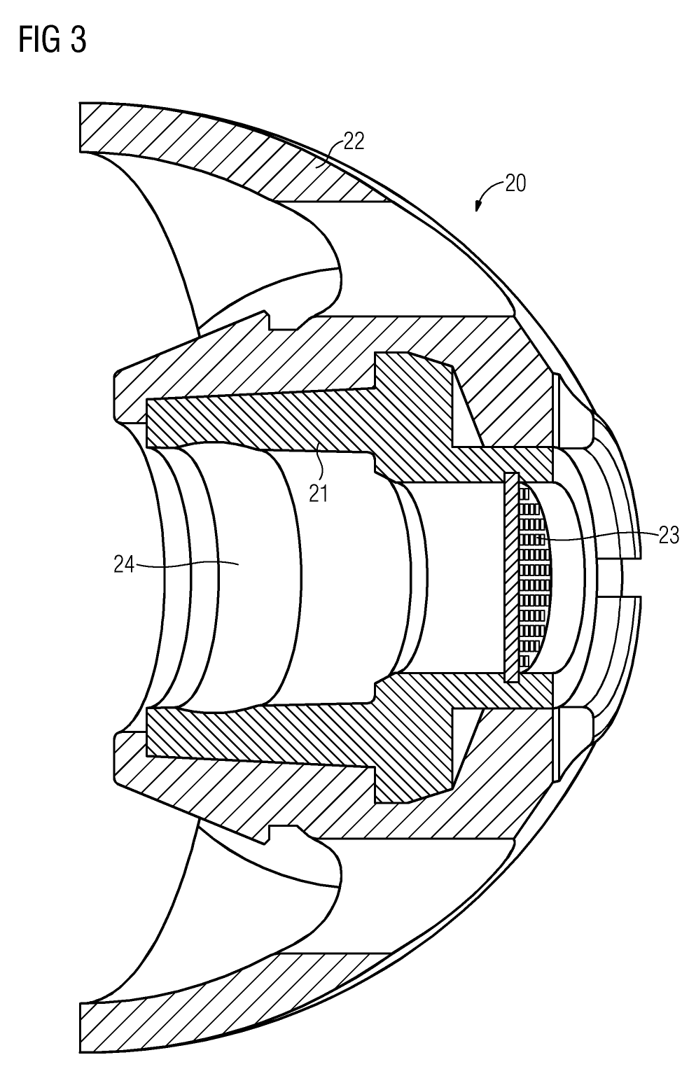

The inventive dome in accordance with FIG. 3 is also composed generally of two parts, an tubular inner section 21 made from a rigid, unyielding plastic material and an outer section 22 connected thereto in one piece made from a soft, flexible plastic material, especially from silicon. Unlike in the prior art, here however a filter element 23 is initially manufactured as a separate component and subsequently connected in one piece to the inner section 21 in an insert-molding process. The initially separate manufacturing of the filter element 23 makes it much more flexible in its configurations, so that it can be better adapted to specific requirements in respect of its acoustic and mechanical filter characteristics. In particular it is also possible in this case to embody the filter element as a metal or ceramic grating. Advantageously the material for the filter element 23 is selected so that it is resistant to a temperature which is generated for a process step necessary for manufacturing the dome 20. Preferably the filter element is made from PEEK, PEK, LCP, PPS, PES or PSU, wherein the composition of the material used is selected so that this withstands temperatures of at least 180°. Thus a silicon material is used for the outer section which can be injected onto the inner section at a temperature of around 140°.

The inventive dome in accordance with FIG. 3 also has a widened-out section of its internal diameter running in the form of a ring in a specific area 24, which forms a part of a snap-on connection so that the dome 20 is also able to be connected detachably to the non-illustrated receiver by a snap-on connection.

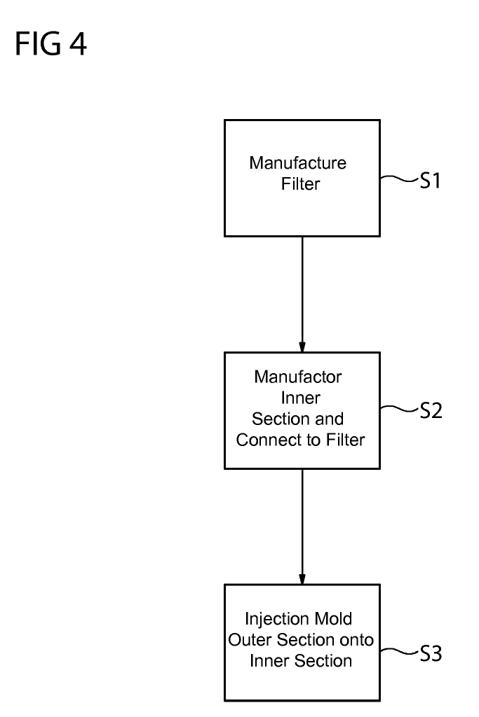

FIG. 4 illustrates the necessary method steps in the manufacturing of an inventive auditory canal insert in accordance with the invention.

In a first method step S1 a filter element made from a temperature-resistant material, e.g. made from PEEK, PEK, LCP, PPS, PES or PSU is manufactured. In a second method step S2 the inner section is manufactured by an insert-molding process and simultaneously connected to the filter element created in the method step S1. Finally, in a third method step S3, the outer section is injected onto the inner section in a multicomponent injection-molding process.

1. An auditory canal insert for a hearing aid, the auditory canal insert comprising:
an auditory canal insert body; and
a filter element, said filter element being initially manufactured as a separate component and is embodied in one piece with said auditory canal insert body by an insert-molding method.

2. The auditory canal insert according to claim 1, wherein said auditory canal insert body has a tubular-shaped inner section and an outer section lying at least in some areas against an auditory canal wall of a user when the auditory canal insert is being worn.

3. The auditory canal insert according to claim 1, wherein said filter element is manufactured from a temperature-resistant plastic material.

4. The auditory canal insert according to claim 3, wherein said filter element is made from a material selected from the group consisting of PEEK, PEK, LCP, PPS, PES and PSU.

5. The auditory canal insert according to claim 1, wherein said filter element is embodied from one of a woven material or includes a woven material.

6. The auditory canal insert according to claim 1, wherein said filter element is embodied as a grating or includes a grating.

7. The auditory canal insert according to claim 6, wherein said grating is made of a material selected from the group consisting of a metal, a metal alloy and a ceramic.

8. The auditory canal insert according to claim 1, wherein said filter element is temperature resistant up to a temperature of at least 120°.

9. The auditory canal insert according to claim 1, wherein said filter element is temperature resistant up to a temperature of at least 150°.

10. The auditory canal insert according to claim 1, wherein said filter element is temperature resistant up to a temperature of at least 180°.

11. The auditory canal insert according to claim 1, wherein said filter element is embodied as an HF4 filter.

12. The auditory canal insert according to claim 2, wherein said outer section is manufactured from a flexible material.

13. The auditory canal insert according to claim 2, wherein said tubular-shaped inner section is manufactured from an unyielding plastic material.

14. The auditory canal insert according to claim 2, wherein said tubular-shaped inner section and said outer section are embodied in one piece.

15. The auditory canal insert according to claim 2, further comprising a receiver.

16. The auditory canal insert according to claim 15, wherein said receiver and said tubular-shaped inner section are able to be connected detachably to each other by a snap-on connection.

17. The auditory canal insert according to claim 2, wherein said outer section is manufactured from a silicon material.

18. A hearing aid, comprising:
an auditory canal insert having a filter element, said filter element being initially manufactured as a separate component and is embodied in one piece with said auditory canal insert by an insert-molding method.

19. A method for manufacturing an auditory canal insert for a hearing aid, the auditory canal insert having a filter element, which comprises the method steps of:
manufacturing the filter element from a temperature-resistant material; and
manufacturing a remainder of the auditory canal insert with the filter element by an insert-molding method.

20. A method for manufacturing an auditory canal insert, the auditory canal insert having a filter element, a tubular inner section, and an outer section lying at least in some area against an auditory canal wall of a user when the auditory canal insert is being worn, which comprises the method steps of:
manufacturing the filter element from a temperature-resistant material;
manufacturing the tubular inner section and connecting the tubular inner section to the filter element by an insert-molding process; and
manufacturing the outer section with the tubular inner section by a multi-component injection-molding process.

21. The method for manufacturing the auditory canal insert according to claim 20, which further comprises making the filter element from a temperature-resistant plastic material.

22. The method for manufacturing the auditory canal insert according to claim 20, which further comprises making the filter element from a material selected from the group consisting of PEEK, PEK, LCP, PPS, PES and PSU.

23. The method for manufacturing the auditory canal insert according to claim 20, which further comprises making the filter element as a grating selected from the group consisting of a metal grating and a ceramic grating.
